(19) United States
(12) Patent Application Publication
(10) Pub. No.: US 2006/0064699 A1
(43) Pub. Date: Mar. 23, 2006

(54) Method and system for processing resource allocations

(76) Inventors: Ted J. Bonk, Cave Creek, AZ (US); Dave Bibby, Scottsdale, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/947,009

(22) Filed: Sep. 21, 2004

(51) Int. Cl. G06F 9/46

(52) U.S. Cl. 718/104

(57) ABSTRACT

A method for allocating resources among common processor is disclosed. In a first step, an application software program is received at a data loader. The application software program comprises an application configuration table (ACT) and an application software executable. Next, a system configuration table (SCT) is received at the data loader. Then the ACT comprising a set of required resources needed for the application software program is compared with the SCT, comprising a set of available resources. If the required resources exceed the available resources, the loading of the application software program is prevented. If the required resources do not exceed the available resources, allocating the required resources to the application software program based on the required resources commences.

### TECHNICAL FIELD OF THE INVENTION

This invention relates to the field of avionics and more specifically to a method and system for processing resource allocations.

### BACKGROUND OF THE INVENTION

Complex machines, such as commercial and military aircraft, are comprised of many different systems operating simultaneously. Each of these systems requires one or more different software processes to operate. For example, various avionics systems, such as radar systems and the like all require multiple software processes to run effectively. Additionally, each of the software processes requires the use of the resources of a processing platform such as memory, processor cycles, and input and output devices. Traditionally, in the area of commercial and military avionics, each needed function for a given system is provided on stand alone line replaceable units (LRU). Each LRU includes its own processor, memory, input/output devices and embedded software. In these systems, often referred to as legacy federated systems, different software is executed independently from each other in an autonomous function. This helps to ensure that different software will not interfere with each other. One benefit of non-interference between LRUs is that getting FAA approval of individual LRUs is relatively straight forward.

There are several drawbacks to federated LRU based systems. For example, the proprietary nature of LRUs results in costly repairs or replacements due to unique equipment design. Further, there is a move in the airline industry towards the greater use of software based functionality. This results in the need to independently develop, data load and certify avionics software applications and to decrease reliance on proprietary hardware and software solutions such as those in federated LRU based systems. Within this need is the need to allocate system resources to software application programs in a cost effective manner.

### SUMMARY OF THE INVENTION

In one embodiment of the present invention a method for allocating resources among common processor is disclosed. In a first step, an application software program is received at a data loader. The application software program comprises an application configuration table (ACT) and an application software executable. Next, a system configuration table (SCT) is received at the data loader. The ACT, comprising a set of required resources needed for the application software program, is compared with the SCT, comprising a set of available resources. If the required resources exceed the available resources, the loading of the application software program is prevented. If the required resources do not exceed the available resources, the required resources are allocated to the application software program based on the required resources commences.

In another embodiment of the present invention an application platform is provided. The application platform comprises a data loader and at least one core program module. The data loader receives an application configuration table of required resources, an application software executable and a system configuration table of available resources operating to host the application software executable. The application software executable is loaded onto the core processing module if the data loader determines the available resources are sufficient to supply the required resources.

### BRIEF DESCRIPTION OF THE DRAWINGS

The present invention will hereinafter be described in conjunction with the following drawing figures, wherein like numerals denote like elements, and:

FIG. 1 is a block diagram of an integrated avionics system in accordance with the teachings of the present invention;

FIG. 2 is a block diagram of the integrated program computer in accordance with the teachings of the present invention;

FIG. 3 is a flowchart illustrating a method for use in accordance with the teachings of the present invention;

FIG. 4 is a block diagram of a software data lad system in accordance with the teachings of the present invention; and

FIG. 5 is a block diagram of a resource allocation system in accordance with the teachings of the present invention.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. While the use of the present invention in the avionics industry is described, the present invention is useful in many fields of endeavor.

The present invention provides for the allocation of system resources for various applications at the time the application software programs are loaded. In the present invention, a system can be loaded with application software programs while avoiding impacting the other software's input/output allocations or time/space partitions. In the present invention, each application software program includes an associated Applications Configuration Table (ACT) that contains a listing of the resources needed by the application. Also included are System Configuration Tables (SCTs) and Platform Configuration Tables (PCTs). The ACTs describe where in the system software program the application software programs reside, the rights assigned to each application software program and the input/output assignments for each application software program. The PCT includes information describing the overall processing capabilities of the processing platform.

In one embodiment of the present invention, when an application is loaded on to the system, the requested resources (as stored in the ACT) are checked and validated against available and allowable resources as outlined in the SCT and PCT. In a further embodiment, a resource allocation process allocates resources as defined in the SCT and PCT to the application software program as required by the ACT.

In the present invention, care is taken such that each application is partitioned properly in both space and time. Time partitioning ensures the protection of processing and communications bandwidth assigned to a partition as well as a partition's access to a prescribed set of hardware resources for a prescribed time period. In time partitioning the order of execution between communication partitions is identical in each time frame. Space partitioning ensures the protection of programs, data, registers and dedicated I/O. Space partitioning ensures that storage locations dedicated to an application software program, such as data memory, can only be written to by the associated application software program.

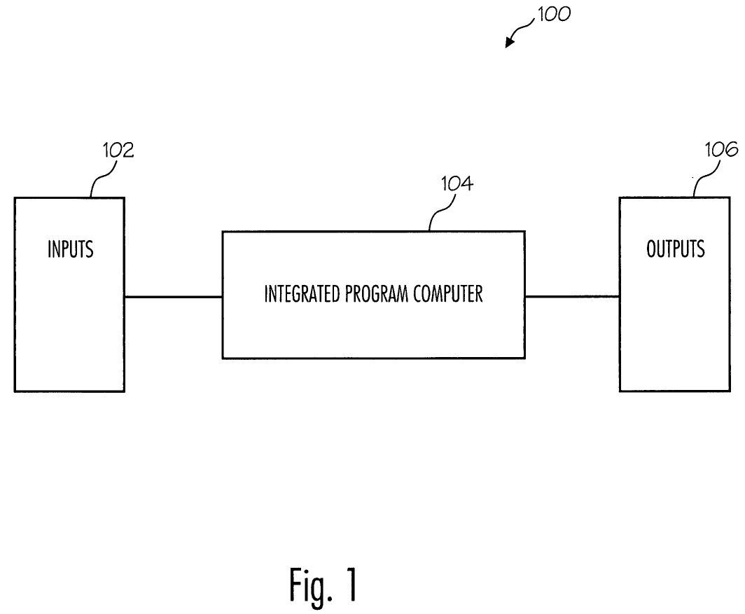

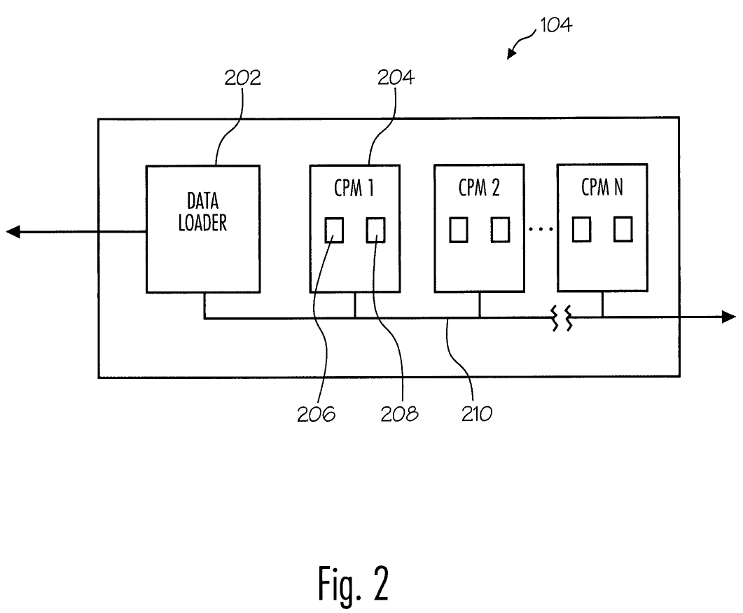

An integrated computing platform 100 is illustrated in FIGS. 1-2. Integrated computing platform 100 comprises an integrated program computer (IPC) 104 coupled to inputs 102 and outputs 106. In an avionics embodiment, inputs 102 can be any input useable by avionics software and can include inputs such as altitude sensors, inputs from control systems and the like. Outputs 106 can be any available output device such as a cockpit display or audio annunciator.

Integrated program computer (IPC) 104 supports the execution of multiple application software programs. In one embodiment of the present invention, IPC 104 includes one or more core processing modules (CPM) 204 comprising a processor 206 and a memory 208. CPM 204 executes application software programs using the processor 206 and the memory 208 of each of the CPMs 204. Memory 208, in one embodiment, may include flash memory for storing program data, non-volatile memory for long term data storage, retained data memory for retaining data during short term interruptions, volatile data memory which is lost in the event of power loss and operating system memory for storing the operating system of the CPM 204. Memory 208 can be any one of these types of memory or a combination of these types of memories. Processor 206 can be any suitable processor.

In one embodiment, a single common operating system is run on all CPMs 204. Each application runs within partitions of the operating system. The applications for each system may run on one or more CPMs 204. Each CPM 204 can be networked or otherwise connected together by connection 210.

IPC 104 further includes at least one data loader 202. Data loader 202 is used to load applications that will run on the CPMs 204. Also, as will be discussed in greater detail below, the data loader 202 will utilize a listing of available resources, the SCT and PCT, to ensure that the application software programs fits within the resources provided at the system and platform level.

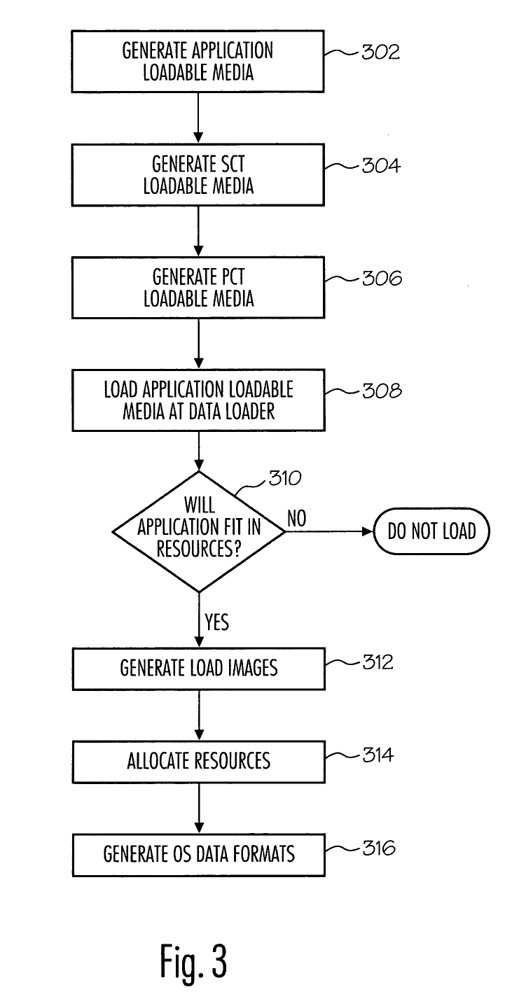

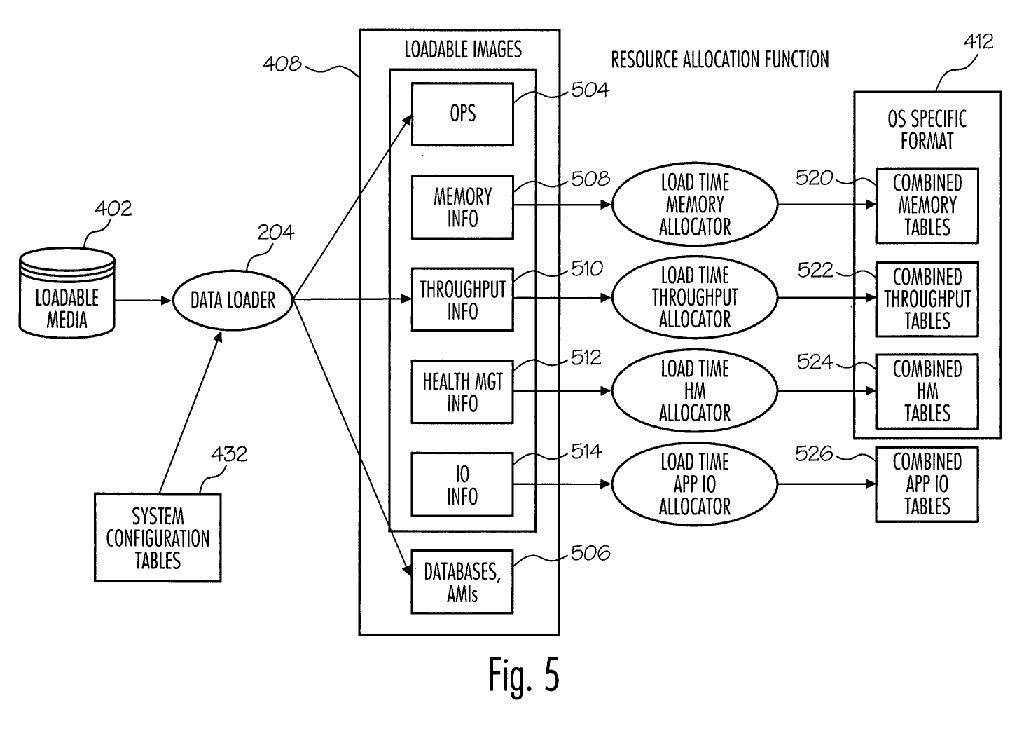

FIGS. 1-2 illustrated a typical hardware system for use with an embodiment of the present invention. FIGS. 3-5 illustrate an exemplary method of use of the present invention.

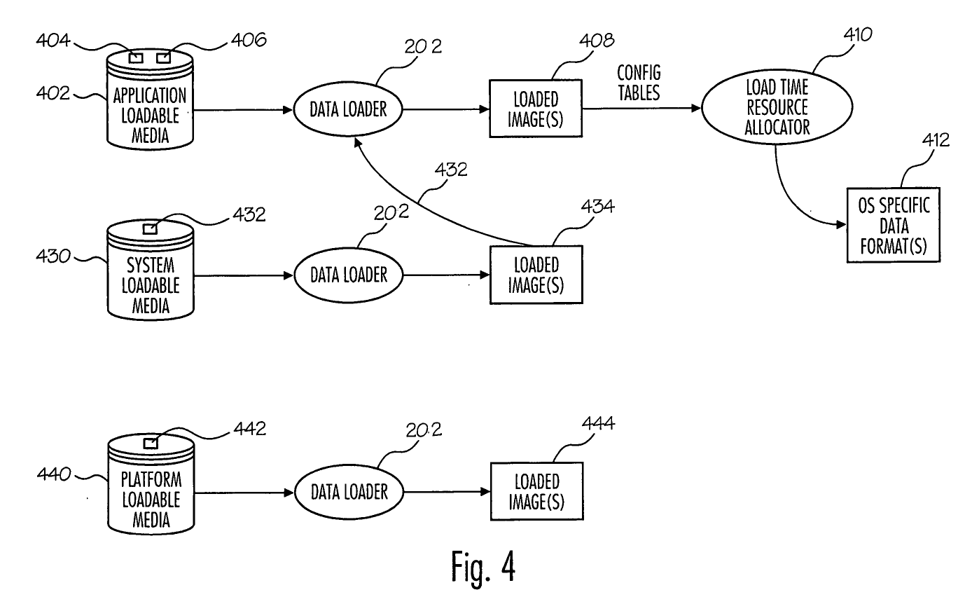

With reference to FIG. 3, which is a flowchart illustrating an exemplary method of use of the present invention, in a first step, step 302, an application software executable is developed and its associated application configuration table (ACT) is also generated. In one embodiment of the present invention, the application software executable and associated ACT are generated by third party software developers and providers as application load media. As illustrated in FIG. 4, application loadable media 402 includes an application software executable 404 and an application configuration table (ACT) 406. The application software executable 404 can be any application needed to operate part of a system or a subsystem such as applications related to a RADAR system. While FIG. 4 illustrates only one application loadable media 402, in a typical embodiment, multiple application loadable medias can be loaded on to a system.

The ACT 406 provides information required by the operating system, the platform and the overall system to run the associated application, frequency of execution of a process in the application software program. In other words, the ACT 406 details the resources needed to operate the application and, through a resource application process allows the application to subscribe to various resources. As seen in FIG. 4, the ACT 406 is provided with the application software executable 404. In one embodiment the ACT 406 can include the following information:

Partition/module configuration information. The partition/module configuration information can include information such as partition identifier, partition name, critical system partition and the like; where each partition is an application software program.

Memory configuration information. Memory configuration information can include memory type, memory size, memory base address and memory access rights.

Throughput configuration information. Throughput configuration information can include a period, which defines the frequency of execution of a process in the application software programs and a period duration, which is the length of execution time for a process.

Input/output configuration information. Input/output configuration information can include the port name, port size for the input/output device, directory, maximum message size and the like.

Health management information. Health management information can include information concerning, among other information, status information about the status of the application software program such as if the program is operating properly and if there has been any software faults.

Application constraint information. Application constraint information can include constraints used by the supplier of the application software program to specify where the application software program can be installed such as on a specific CPM or a specific memory location.

In a next step, step 304, a system configuration table (SCT) 432 is generated, in one embodiment, as part of a system loadable media 430. The SCT 432 is typically generated by the system integrator or designer when the system is designed. Examples of systems include the RADAR system, cockpit display system and the like. In a typical embodiment, the SCT 432 includes information regarding the applications related to the system as well as any databases related to the system. The SCT 432 can include such information as the number of partitions/application software programs for the system, the location of each partition for the system, partition numbers for the system and the like. Further, SCT 432 can also include input/output source assignments for each partition in the system.

In step 306, a platform configuration table (PCT) 442 is generated as part of a platform load media 440. PCT 442 defines the available resources on a platform level. The PCT can include all or part of the following information.

Module configuration information. Module configuration information can include module name and module version. A module is the hardware processing element that hosts the application software program. CPM 204 is an example of a module.

Hardware configuration information. Hardware configuration information can include memory, throughput and input/output capability.

Memory configuration information. Memory configuration information can include information regarding installed memory.

Throughput configuration information. Throughput configuration information can include information regarding the length of a major frame as well as other platform specific information.

Input/Output configuration information. Input/output configuration information can include information for each port in the platform and the like.

Health management configuration information. Health management configuration information can include information regarding the state of the system as well as error information.

In step 308, the application loadable media 402 is loaded by data loader 202. At this time, the SCT 432 is also loaded by data loader 202. Next, in step 310, prior to loading the application, the data loader 202 checks the ACT 406 and the SCT 432 to insure that the application will fit within resource constraints. If the available resources are less than the required resources the application is not loaded. Also in this step, the application is not loaded if any application constraints listed in the ACT 406 will be violated.

Next, in step 312, loaded images of the contents of application loadable media 402 are produced. These include an operational program software (OPS) 502, which is the application software executable, as well as any databases and airline modifiable information 506 needed for the OPS 502. Also, a loaded image of the ACT 406 is also produced. The images can include memory information 508, throughput information 510, health management information 512, and I/O information 514.

In a next step, step 314, a resource allocation is done using resource allocator 410. Resource allocation using resource allocator 410, in one embodiment, is done at one of the CPMs 204. The resource allocation uses the information found in ACT 406 in conjunction with the information found in SCT 432 to allocate applications to a particular CPM 204, as well as to allocate memory usage, processing usage, I/O devices usage and any other resources. During the allocation process, the resource allocation process refers to the PCT 442 to ensure that total resources for the platform are not exhausted.

After the resources are allocated to an application, operating system (OS) specific data 412 is generated. OS specific data 412 include tables formulated to be useable by the specific OS. Operating systems require specific information regarding applications in a specific format to execute applications properly. The OS specific data 412 provides the specific information. For example, combined memory tables 520, combined throughput memory tables 520, combined throughput tables 524, combined health management tables 526 and combined I/O tables 528.

While FIGS. 3-5 illustrated the allocation of resources at load/run time, resources allocation, in one embodiment of the present invention, resource resources allocation, in one embodiment of the present invention, resource allocation can occur at other times, such as on a power up. This allows for the reallocation of system resources in the event of a failure of one or more software programs.

By providing the functionality based on software and resource allocation based on tables specific to applications, systems and platforms, certification of a software by the FAA is made easier. Specifically, when a change is made to a software program, the change in the ACT will be generated. Thus, recertification is made simpler.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalent thereof.

What is claimed:

1. A method for allocating resources among common processors comprising:
receiving an application software program at a data loader, the application software program comprising an application configuration table of required resources and an application software executable;
receiving a system configuration table of available resources at the data loader;
comparing the application configuration table of required resources needed for the application software executable with the system configuration table of available resources;
preventing the loading of the application software executable if the required resources exceed the available resources; and
allocating the available resources to the application software executable based on the required resources, if the required resources do no exceed the available resources.

2. The method of claim 1 wherein the step of allocating the required resources to the application software executable based on the required resources further comprising allocating a memory usage, a processor usage and an input/output device usage.

3. The method of claim 1 further comprising allocating resources at a start up to allow for reallocation of system resources in the event of a failure of one or more software programs.

4. The method of claim 1 further comprising the steps of:
detecting if a loading constraint included in the application configuration table exists; and
preventing the loading of the application software executable if the loading constraint exists.

5. The method of claim 1 further comprising the step of generating a set of loaded images from the application software executables.

6. The method of claim 1 further comprising the step of generating a set of operating system specific data formats.

7. An apparatus for loading and hosting software applications comprising:
a data loader that receives an application configuration table of required resources, an application software executable and a system configuration table of available resources;
at least one core program module operable to host the application software executable if the data loader determines if the available resources are sufficient to supply the required resources.

8. The apparatus of claim 7 further comprising a resource allocator for allocating available resources to the application program executable.

9. The apparatus of claim 8 wherein the resource allocator is further operable to generate a set of operating system data formats.

10. The apparatus of claim 7 wherein the data loader and each of the core processing units are coupled via a network.

11. The apparatus of claim 7 wherein the apparatus is coupled to a data input and a data output.

12. The apparatus of claim 7 wherein the data loader prevents the loading of the application software executable of a constraint listed in the application configuration table exists.

13. A method for allocating resources of a computer platform comprising:
comparing a set of required resources for an application with a set of available resources;
loading the application onto a core processing module if the required resources are within the set of available resources; and
preventing the loading of the application if the required resources exceed the available resources.

14. The method of claim 13 further comprising generating an application configuration table comprising a listing of required resources for an associated application software executable prior to the step of comparing.

15. The method of claim 13 further comprising generating a system configuration table comprising a listing of available resources for a given system prior to the step of comparing.

16. The method of claim 13 further comprising allocating available resources to the application based on required resources.

17. The method of claim 13 further comprising generating operating system data formats.

18. A platform computer for use in hosting avionic software for one or more avionic systems comprising:
one or more avionic inputs,
one or more avionic outputs;
an integrated program platform coupled between the avionic inputs and the avionic outputs, the integrated program computer further comprising:
a data loader that receives an application configuration table of required resources, an application software executable and a system configuration table of available resources;
at least one core program module operable to host the application software executable if the data loader determines if the available resources are sufficient to supply the required resources.

19. The platform computer of claim 17 further comprising a resource allocator for allocating available resources to the application program executable.

20. The platform computer of claim 18 wherein the resource allocator is further operable to generate a set of operating system data formats.
